(19) United States
(12) Patent Application Publication
(10) Pub. No.: US 2022/0301466 A1
(43) Pub. Date: Sep. 22, 2022

(54) PROJECTION SYSTEM AND STITCHING METHOD OF MULTIPLE PROJECTION IMAGES

(71) Applicant: Coretronic Corporation, Hsin-Chu (TW)

(72) Inventors: Hsun-Cheng Tu, Hsin-Chu (TW); Chun-Lin Chien, Hsin-Chu (TW); Chi-Wei Lin, Hsin-Chu (TW); Chien-Chun Peng, Hsin-Chu (TW)

(73) Assignee: Coretronic Corporation, Hsin-Chu (TW)

(21) Appl. No.: 17/671,613

(22) Filed: Feb. 15, 2022

(30) Foreign Application Priority Data
Mar. 19, 2021 (CN) 202110294236.0

(51) Int. Cl. G09G 3/00

(52) U.S. Cl. CPC G09G 3/002; G09G 2300/026; G09G 2340/0442; G09G 2340/12

(57) ABSTRACT

A projection system is provided, which includes multiple projection devices. The projection devices are configured to generate multiple projection images. Each of the projection images partially overlaps with at least one of the adjacent projection images. In a viewing direction, aspect ratios of the projection images are all greater than 1 or less than 1. A projection direction of one of the projection devices is not parallel to a projection direction of another one of the projection devices. A stitching method of the projection images is further provided. The projection system and the stitching method of the projection images provided by the disclosure have a better effect of the projection images.

### CROSS-REFERENCE TO RELATED APPLICATION

This application claims the priority benefit of China application serial no. 202110294236.0, filed on Mar. 19, 2021. The entirety of the above-mentioned patent application is hereby incorporated by reference herein and made a part of this specification.

### BACKGROUND

### Technical Field

The disclosure relates to an optical system and a stitching method, and more particularly, to a projection system and a stitching method of multiple projection images.

### Description of Related Art

Image stitching of an ultra-short focus projector is an application when projecting large-size images, and when the viewing distance is short, or the disposing space is limited. However, due to the characteristic that the ultra-short focus projector is disposed on the same plane as a projection image, or needs to keep a short distance from the disposing surface, the position and number of machines disposed for a stitching application are easily restricted. For example, in the stitching of a 2×2 projection image, in order to prevent the projector from interfering with the image, it is impossible to add the ultra-short focus projector in the middle of the vertical direction. In addition, if a horizontal projector is required to stitch more than 2×2 machines, such as 3×2 machines, two different projection directions are used to project. However, because a short side of one projection image needs to be stitched with a long side of another one projection image, one of the projection images needs to be scaled up, which leads to reduced brightness and resolution, and affects the overall stitching display effect. Moreover, when overlapping the images, it is also limited by the distance between the projectors in the same projection direction. As a result, an image area of the respective projectors overlapping with one another is less, and an image ratio after overlapping is very different from the original projector, so that in the projection images after overlapping, a ratio of black images that do not display images is higher, and the image utilization rate is reduced.

In addition, as for image capturing required for the image processing or interactive application, if it is used with an image capturing device that uses the original image capturing angle to complete the automatic stitching and fusion correction, the image capturing distance needs to be extended during imaging capturing, resulting in a decrease in a ratio of the projection image in the imaging capturing image. However, due to low resolution of the image capturing, it is difficult to accurately stitch the images in the image processing, or the images may be cut off due to the capturing angle of the image capturing device.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a projection system and a stitching method of multiple projection images, which may effectively improve an effective utilization rate of the projection images, so that the stitched projection images render a favorable effect.

An embodiment of the disclosure provides a projection system according an embodiment of the disclosure, which includes multiple projection devices. The projection devices are configured to generate multiple projection images. Each of the projection images partially overlaps with at least one of the adjacent projection images. In a viewing direction, aspect ratios of the projection images are all greater than 1 or less than 1. A projection direction of one of the projection devices is not parallel to a projection direction of another one of the projection devices.

An embodiment of the disclosure provides a stitching method of multiple projection images according an embodiment of the disclosure, which includes the following steps. The projection images are respectively projected by multiple projection devices. Each of the projection images partially overlaps with at least one of the adjacent projection images. In a viewing direction, aspect ratios of the projection images are all greater than 1 or less than 1. A projection direction of one of the projection devices is not parallel to a projection direction of another one of the projection devices.

Based on the above, in the projection system and the stitching method of the projection images according to an embodiment of the disclosure, each of the projection images partially overlaps with the at least one of the adjacent projection images, and in the viewing direction, the aspect ratios of the projection images are all greater than 1 or less than 1. Therefore, the projection system and the stitching method of the projection images may effectively improve an effective utilization rate of the projection images, so that the stitched projection images render a favorable effect.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a projection system according to an embodiment of the disclosure.

FIG. 2 is a schematic perspective view of another projection system according to an embodiment of the disclosure.

FIG. 3 is a schematic view of a projection device 100A and an image capturing device 200A in FIG. 1.

FIG. 4 is a schematic view of a projection device 100B and an image capturing device 200B in FIG. 1.

FIG. 5 is a schematic view of yet another projection system according to an embodiment of the disclosure.

FIG. 6 is a schematic view of still another projection system according to an embodiment of the disclosure.

FIG. 7 is a flowchart of a stitching method of multiple projection images according to an embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

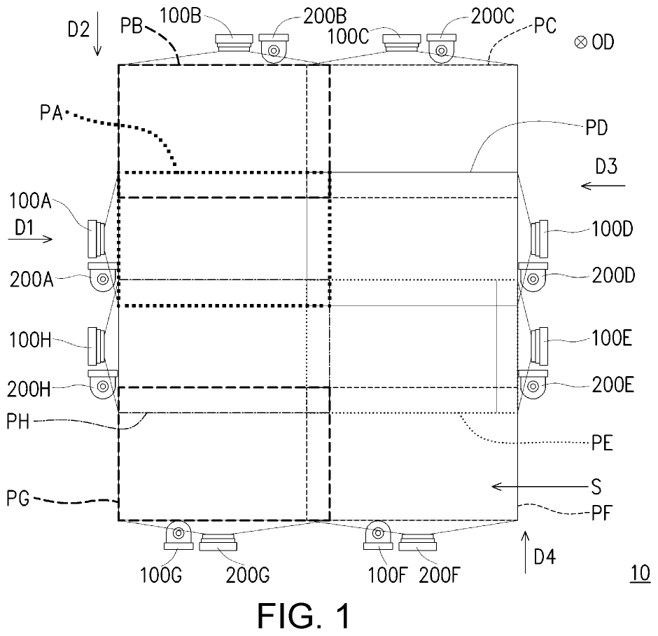

FIG. 1 is a schematic view of a projection system according to an embodiment of the disclosure. Referring to FIG. 1, an embodiment of the disclosure provides a projection system 10, which includes multiple projection devices 100A, 100B, 100C, 100D, 100E, 100F, 100G, and 100H. The projection devices 100A, 100B, 100C, 100D, 100E, 100F, 100G, and 100H may be ultra-short focus projectors, which are configured to generate multiple projection images PA, PB, PC, PD, PE, PF, PG, and PH. In FIG. 1, the respective projection images PA, PB, PC, PD, PE, PF, PG, and PH are front projection images, so that a viewer sees a reflected light from a projection surface S. The projection surface S is an opaque surface, such as a projection screen, and the projection surface S may be a flat surface or a curved surface. The viewer and the projection device are located on the same side of the projection surface S. In other embodiments, the respective projection images PA, PB, PC, PD, PE, PF, PG, and PH may also be rear projection images, so that the viewer sees a transmitted light from the projection surface S.

In this embodiment, the projection images PA, PB, PC, PD, PE, PF, PG, and PH are the front projection images and are arranged in an n×m matrix, and n is greater than or equal to 2, and m is greater than or equal to 1, or n is greater than or equal to 3, and m is greater than or equal to 2. In FIG. 1, the projection images generated by the projection devices 100A, 100B, 100C, 100D, 100E, 100F, 100G, and 100H are arranged in a 4×2 matrix, and the respective front projection images are not interfered by the projection devices.

In this embodiment, each of the projection images PA, PB, PC, PD, PE, PF, PG, and PH partially overlaps with at least one of the adjacent projection images PA, PB, PC, PD, PE, PF, PG, and PH. Taking FIG. 1 as an example, the projection image PA generated by the projection device 100A partially overlaps with the projection images PB, PC, PD, PE, and PH. FIG. 1 illustrates that the projection images PA, PB, PC, PD, PE, and PH partially but not completely overlap, but the disclosure is not limited thereto.

In this embodiment, in a viewing direction OD, aspect ratios of the projection images PA, PB, PC, PD, PE, PF, PG, and PH are all greater than 1 or less than 1, and the viewing direction OD is the direction toward (for example, perpendicular to) the projection image PA or the projection surface S. In particular, the viewing direction OD is the direction in which the general viewer stands (or sits) without turning his head to face the projection surface S. A width refers to a length in a horizontal direction (for example, the direction parallel to a projection direction D1 in the embodiment of FIG. 1), and a height refers to a length in a vertical direction (for example, the direction parallel to a projection direction D2 in the embodiment of FIG. 1). The aspect ratio is, for example, 16:9, 4:3, 9:16, 3:4, or depends on design requirements. In the viewing direction OD, the projection image having the aspect ratio greater than 1 is defined as a horizontal projection image, for example, a landscape mode, and the projection image having the aspect ratio less than 1 is defined as a vertical projection image, for example, a portrait mode. Projection directions D1, D2, D3, and D4 of one of the projection devices 100A, 100B, 100C, 100D, 100E, 100F, 100G, and 100H are not parallel to the projection directions D1, D2, D3, and D4 of another one of the projection devices 100A, 100B, 100C, 100D, 100E, 100F, 100G, and 100H (for example, in this embodiment, an included angle between the projection direction D1 and the projection direction D2 is about 90 degrees, or between 80 degrees and 100 degrees). The projection directions D1, D2, D3, and D4 are the directions that the projection devices 100A, 100B, 100C, 100D, 100E, 100F, 100G, and 100H face toward centers of the respectively generated projection images PA, PB, PC, PD, PE, PF, PG and PH, that is, light emitting directions of image beams (center beams) of the projection devices.

Furthermore, in this embodiment, the projection devices of the projection system 10 include the projection device 100A, 100D, 100E, and 100H (for example, first projection devices), and the projection devices 100B, 100C, 100F, and 100G (for example, second projection devices). The projection devices 100A, 100D, 100E, and 100H generate the projection images PA, PD, PE, and PH (for example, first projection images) along the projection direction D1 (for example, a first projection direction) or the projection direction D3 (for example, the projection direction D1 anti-parallel to the projection direction D3). The projection images PA, PD, PE, and PH are the horizontal projection images, and the projection devices 100A, 100D, 100E, and 100H are in vertical projection modes. The projection devices 100B, 100C, 100F, and 100G generate the projection images PB, PC, PF, and PG (for example, second projection images) along the projection direction D2 (for example, a second projection direction) or the projection direction D4 (for example, the projection direction D2 anti-parallel to the projection direction D4). The projection images PB, PC, PF, and PG are the horizontal projection images, and the projection devices 100B, 100C, 100F, and 100G are the in horizontal projection modes. Therefore, the aspect ratios of the projection images PA, PD, PE, and PH along the projection direction D1 or D3 are different from the aspect ratios of the projection images PB, PC, PF, and PG along the projection direction D2 or D4, and the projection direction D1 is perpendicular to the second projection direction D2.

In FIG. 1, in order to achieve that the aspect ratios of the projection images PA, PD, PE, and PH along the projection direction D1 or D3 are different from the aspect ratios of the projection images PB, PC, PF, and PG along the projection direction D2 or D4, the projection devices 100A, 100D, 100E, and 100H, for example, convert the projection images by using light path turning elements disposed outside the projection devices, so as to generate the projection images PA, PH, PD, and PE with the aspect ratios of less than 1 along the projection direction D1 or D3 of the projection devices. However, the disclosure is not limited thereto.

In this embodiment, the projection devices 100A, 100B, 100C, 100D, 100E, 100F, 100G, and 100H may all be disposed on the same plane. For example, in FIG. 1, the projection devices 100A, 100B, 100C, 100D, 100E, 100F, 100G, and 100H and the projection surface S are all disposed on the same plane, but the disclosure is not limited thereto. In the projection system 10 of an embodiment of the disclosure, in the viewing direction OD, the aspect ratios of the projection images PA, PB, PC, PD, PE, PF, PG, and PH may be greater than 1 or less than 1, respectively. Therefore, even if the projection devices 100A, 100B, 100C, 100D, 100E, 100F, 100G, and 100H are the ultra-short focus projectors, the projection devices 100A, 100B, 100C, 100D, 100E, 100F, 100G, and 100H of the projection system 10 may still be disposed on the same plane to enable the projection images be arranged in the n×m matrix. Compared with a general projection system, multiple projection devices may only provide projection images with the same aspect ratio, and the projection images generated by the projection devices cannot be arranged in a matrix that includes 2×3 or more when the projection devices are all disposed on the same plane.

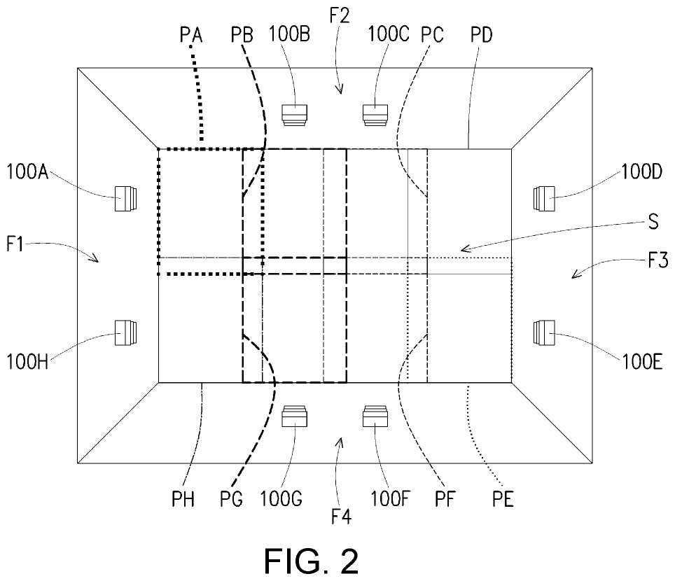

FIG. 2 is a schematic perspective view of another projection system according to an embodiment of the disclosure. Referring to FIG. 2, in this embodiment, the projection devices are respectively disposed at least on two different planes. In detail, the projection devices 100A and 100H are disposed on a disposing surface F1. The projection devices 100B and 100C are disposed on a disposing surface F2. The projection devices 100D and 100E are disposed on a disposing surface F3, and the projection devices 100F and 100G are disposing on a disposing surface F4. The disposing surfaces F1, F2, F3, and F4 are perpendicular to the projection surface S, and the disposing surfaces F1 and F3 are perpendicular to the disposing surfaces F2 and F4. For example, the disposing surfaces F1 and F3 are wall surfaces. The disposing surface F2 is a ceiling, and the disposing surface F4 is a floor. In this embodiment, the projection images PA, PB, PC, PD, PE, PF, PG, and PH are all the vertical projection images. The projection devices 100A, 100D, 100E, and 100H are in the horizontal projection modes, and the projection devices 100B, 100C, 100F, and 100G are in the vertical projection modes. In FIG. 2, shortest distances between the projection devices 100A, 100B, 100C, 100D, 100E, 100F, 100G, and 100H and the projection surface S are substantially the same, so that the projection devices 100A, 100B, 100C, 100D, 100E, 100F, 100G, and 100H are substantially located on a plane parallel to the projection surface S.

In another embodiment, the projection devices 100A, 100B, 100C, 100D, 100E, 100F, 100G, and 100H are respectively disposed on at least two different planes. For example, the shortest distances between the projection devices 100A, 100D, 100E, and 100H and the projection surface S are substantially the same, and the shortest distances between the projection devices 100B, 100C, 100F, and 100G and the projection surface S are substantially the same. However, the shortest distance between the projection device 100A and the projection surface S is different from the shortest distance between the projection device 100B and the projection surface S. Therefore, the projection devices 100A, 100D, 100E, and 100H are located on the same plane, and the projection devices 100B, 100C, 100F, and 100G are located on another plane. The aforementioned two planes are parallel to each other. In still another embodiment, the shortest distances between the projection device 100A, 100B, 100C, 100D, 100E, 100F, 100G, and 100H and the projection surface S may be determined according to the design requirements.

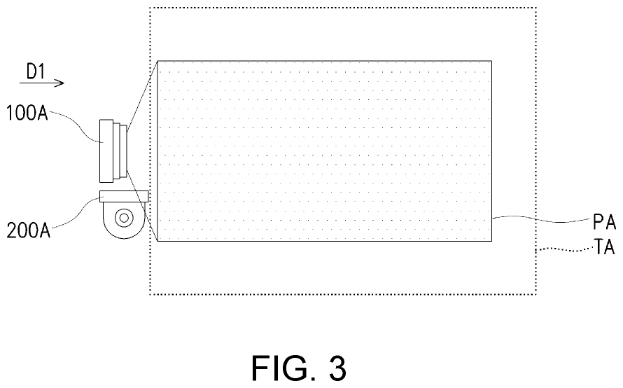

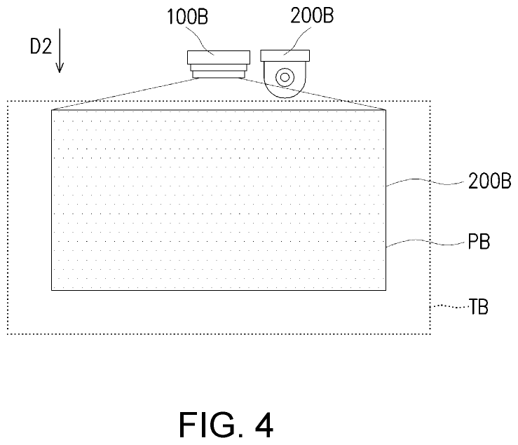

FIG. 3 is a schematic view of a projection device 100A and an image capturing device 200A in FIG. 1. FIG. 4 is a schematic view of a projection device 100B and an image capturing device 200B in FIG. 1. Referring to FIGS. 1, 3, and 4 together, in this embodiment, the projection system 10 further includes multiple image capturing devices 200A, 200B, 200C, 200D, 200E, 200F, 200G, and 200H, which are configured to detect image aspect ratios and an image coordinate accuracy of the projection images PA, PB, PC, PD, PE, PF, PG and PH (for example, through a grid point identification). The image capturing devices 200A, 200B, 200C, 200D, 200E, 200F, 200G, and 200H respectively correspond to the different projection images PA, PB, PC, PD, PE, PF, PG, and PH to generate multiple image capturing images. For example, the image capturing device 200A corresponds to the projection image PA to generate an image capturing image TA, as shown in FIG. 3. In addition, the image capturing device 200B corresponds to the projection image PB to generate an image capturing image TB, as shown in FIG. 4. In this embodiment, the image capturing devices 200A, 200B, 200C, 200D, 200E, 200F, 200G, and 200H are preferably disposed next to the corresponding projection devices. In an embodiment of the disclosure, since the projection system 10 is provided with the corresponding image capturing devices 200A, 200B, 200C, 200D, 200E, 200F, 200G, and 200H, the stitching effect of the projection images PA, PB, PC, PD, PE, PF, PG, and PH generated by the projection system 10 is better.

In this embodiment, the image capturing device 200A, 200B, 200C, 200D, 200E, 200F, 200G, and 200H may change an image capturing direction according to the horizontal projection mode or the vertical projection mode of the corresponding projection device. For example, when the aspect ratio of the projection image PA along the projection direction D1 of the projection device 100A is less than 1, the aspect ratio of the image capturing image TA corresponding to the projection image PA is less than 1, as shown in FIG. 3. When the aspect ratio of the projection image PB along the projection direction D2 of the projection device 100B is greater than 1, the aspect ratio of the image capturing image TB corresponding to the projection image PB is greater than 1, as shown in FIG. 4. In this way, for example, the image capturing images TA and TB may completely cover the corresponding projection images PA and PB, and also cover a portion of the adjacent projection images. Therefore, the projection system 10 may render a much better stitching effect of the projection images PA, PB, PC, PD, PE, PF, PG, and PH.

Based on the above, in the projection system 10 according to an embodiment of the disclosure, each of the projection images PA, PB, PC, PD, PE, PF, PG, and PH partially overlaps with the at least one of the adjacent projection images, and when the projection directions D1, D2, D3, and D4 of the projection devices 100A, 100B, 100C, 100D, 100E, 100F, 100G, and 100H may not be parallel to each other, in the viewing direction OD, the aspect ratios of the projection images PA, PB, PC, PD, PE, PF, PG, and PH are all greater than 1 or less than 1. Therefore, the projection system 10 may effectively improve the effective utilization rate of the projection images, so that the stitched projection images render a favorable effect. Moreover, in the stitching of the projection images, an image magnification rate of each of the projection images PA, PB, PC, PD, PE, PF, PG, and PH is not different from the aspect ratio thereof. Therefore, the overall brightness and resolution of the projection images are better.

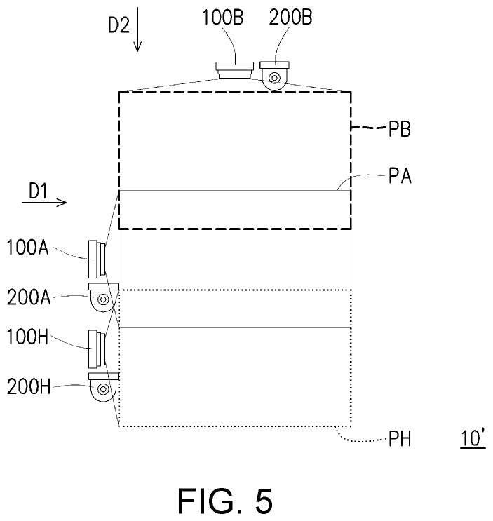

FIG. 5 is a schematic view of yet another projection system according to an embodiment of the disclosure. Referring to FIG. 5, a projection system 10′ of FIG. 5 is similar to the projection system 10 of FIG. 1, and the main difference is that the projection images PB, PA, and PH generated by the projection devices 100B, 100A, and 100H are arranged in a 3×1 matrix. The projection direction of the projection device 100B are not parallel to that of the projection device 100A, and the projection direction of the projection device 100H is parallel to that of the projection device 100A. Three sides of the projection image PB partially overlap with the adjacent projection image PA, and three sides of the projection image PH partially overlap with the adjacent projection image PA. However, the disclosure is not limited thereto. In other embodiments, an n×1 matrix may be arranged along the projection direction D2, and n may be greater than 3. That is, the projection devices may be disposed in the direction of the projection direction D2 to extend the stitched projection images.

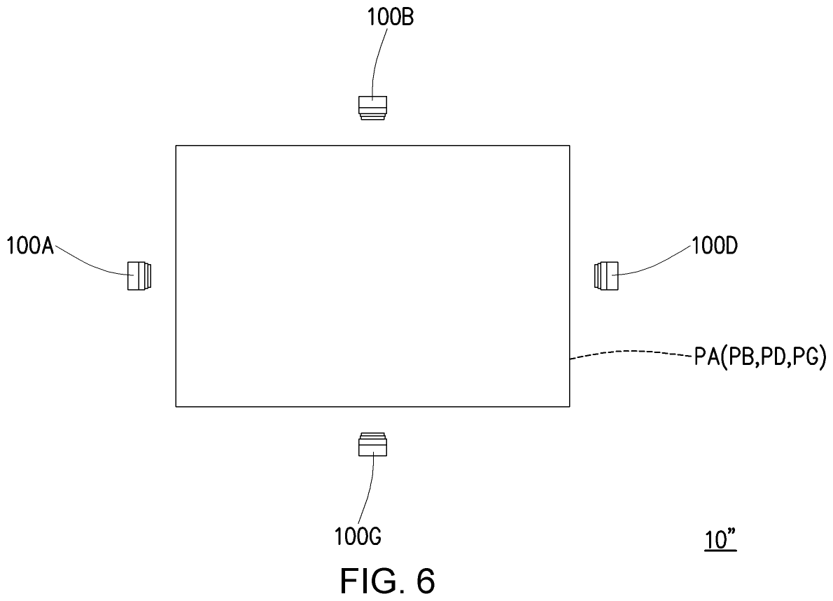

FIG. 6 is a schematic view of still another projection system according to an embodiment of the disclosure. Referring to FIG. 6, a projection system 10″ of FIG. 6 is similar to the projection system 10 of FIG. 1, and the main difference is that the projection system 10″ includes the projection devices 100A, 100B, 100D, and 100G, and the projection image PA may almost completely overlap with at least one of the projection images PB, PD, and PG. For example, in this embodiment, the projection image PA almost completely overlaps with the projection images PB, PD, and PG. Furthermore, the respective projection devices of the projection system 10″ may generate the projection images from different directions. Therefore, at least three projection images or more may almost completely overlap, so that the maximum brightness of the overall projection image generated by the projection system 10″ is much higher. In particular, the almost complete overlap of the projection images refers to an overlapping area that is greater than or equal to 95% or more or 98% or more of the projection image. For example, the overlapping area of the projection image PA and the at least one of the projection images (e.g., the projection image PB) is greater than or equal to 95% of the projection image PA. In other words, an area of the black image (non-overlapping area) where the projection image PA does not display an image is less than 5% of the projection image PA. Compared with the general projection system where the projection images completely overlap from the upper and lower or left and right sides, or parallel the projection device to enable the non-overlapping area to be located on the left and right sides or the upper and lower sides of the projection surface S, and the non-overlapping area is at least greater than 10% of the projection image, the projection system 10″ of the disclosure may render a good effect of projection brightness by overlapping the projection images from different directions (or at least three or more directions). Multiplying the brightness of the overlapping area is beneficial to use the projection system 10″ according to the embodiment of the disclosure in an environment with a bright background light.

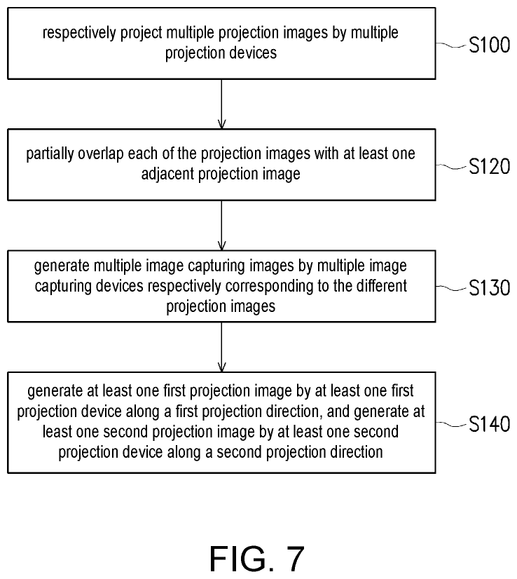

FIG. 7 is a flowchart of a stitching method of multiple projection images according to an embodiment of the disclosure. Referring to both FIGS. 1 and 7, in this embodiment, the stitching method of the projection images includes the following steps. In step S100, the projection images PA, PB, PC, PD, PE, PF, PG, and PH are respectively projected by the projection devices 100A, 100B, 100C, 100D, 100E, 100F, 100G, and 100H. The projection images PA, PD, PE, and PH along the projection direction D1 or D3 are the vertical projection images, and the projection images PB, PC, PF, and PG along the projection direction D2 or D4 are the horizontal projection images. In step S120, each of the projection images PA, PB, PC, PD, PE, PF, PG, and PH partially overlap with the at least one of the adjacent projection images. In the viewing direction OD, the aspect ratios of the projection images PA, PB, PC, PD, PE, PF, PG, and PH are all greater than 1 or less than 1.

In this embodiment, the stitching method of the projection images further includes the following step. In step S130, the image capturing images are generated by the image capturing devices 200A, 200B, 200C, 200D, 200E, 200F, 200G, and 200H respectively corresponding to the different projection images PA, PB, PC, PD, PE, PF, PG, and PH.

In this embodiment, the stitching method of the projection images further includes the following steps. In step S140, at least one of the first projection images PA, PD, PE, and PH are generated by at least one of the first projection devices 100A, 100D, 100E, and 100H along the first projection direction D1 or D3. At least one of the second projection images PB, PC, PF, and PG are generated by at least one of the second projection devices 100B, 100C, 100F, and 100G along the second projection direction D2 or D4.

Based on the above, in the projection system and the stitching method of the projection images according to an embodiment of the disclosure, each of the projection images partially overlaps with the at least one of the adjacent projection images, and when the projection directions of the projection devices may not be parallel to each other, in the viewing direction, the aspect ratios of the projection images are all greater than 1 or less than 1. Therefore, the projection system and the stitching method of the projection images may effectively improve the effective utilization rate of the projection images, so that the stitched projection images render the favorable effect.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection system, comprising a plurality of projection devices to generate a plurality of projection images, wherein
each of the plurality of projection images partially overlaps with at least one adjacent projection image,
in a viewing direction, aspect ratios of the plurality of projection images are all greater than 1 or less than 1, and
a projection direction of one of the plurality of projection devices and a projection direction of another one of the plurality of projection devices are not parallel to each other.

2. The projection system according to claim 1, wherein the plurality of projection images are arranged in an n×m matrix, wherein n is greater than or equal to 2, and m is greater than or equal to 1.

3. The projection system according to claim 1, further comprising:
a plurality of image capturing devices respectively corresponding to the plurality of different projection images to generate a plurality of image capturing images, wherein
in the respective projection images of the plurality of projection devices, when an aspect ratio of the projection image along a projection direction of the projection device is less than 1, an aspect ratio of the image capturing image corresponding to the projection image is less than 1, and when an aspect ratio of the projection image along a projection direction of the projection device is greater than 1, an aspect ratio of the image capturing image corresponding to the projection image is greater than 1.

4. The projection system according to claim 1, wherein the plurality of projection devices are disposed on a same plane.

5. The projection system according to claim 1, wherein the plurality of projection devices are respectively disposed on at least two different planes.

6. The projection system according to claim 1, wherein the plurality of projection devices comprise:
at least one first projection device generating at least one first projection image along a first projection direction; and
at least one second projection device generating at least one second projection image along a second projection direction, wherein an aspect ratio of the at least one first projection image along the first projection direction is different from an aspect ratio of the at least one second projection image along the second projection direction, wherein the first projection direction is perpendicular to the second projection direction.

7. The projection system according to claim 6, wherein an overlapping area of the at least one first projection image and the at least one second projection image is greater than or equal to 95% of the at least one first projection image.

8. A stitching method of a plurality of projection images, comprising:
respectively projecting the plurality of projection images by a plurality of projection devices; and
partially overlapping each of the plurality of projection images with at least one adjacent projection image, wherein
in a viewing direction, aspect ratios of the plurality of projection images are all greater than 1 or less than 1, and
a projection direction of one of the plurality of projection devices and a projection direction of another one of the plurality of projection devices are not parallel to each other.

9. The stitching method of the plurality of projection images according to claim 8, wherein the plurality of projection images are arranged in an n×m matrix, wherein n is greater than or equal to 2, and m is greater than or equal to 1.

10. The stitching method of the plurality of projection images according to claim 8, further comprising:
generating a plurality of image capturing images by a plurality of image capturing devices respectively corresponding to the plurality of different projection images, wherein
in the respective projection images of the plurality of projection devices, when an aspect ratio of the projection image along a projection direction of the projection device is less than 1, an aspect ratio of the image capturing image corresponding to the projection image is less than 1, and when an aspect ratio of the projection image along a projection direction of the projection device is greater than 1, an aspect ratio of the image capturing image corresponding to the projection image is greater than 1.

11. The stitching method of the plurality of projection images according to claim 8, wherein the plurality of projection devices are disposed on a same plane.

12. The stitching method of the plurality of projection images according to claim 8, wherein the plurality of projection devices are disposed on at least two different planes.

13. The stitching method of the plurality of projection images according to claim 8, wherein the plurality of projection devices comprise at least one first projection device and at least one second projection device, and the stitching method of the plurality of projection images further comprises:
generating at least one first projection image by the at least one first projection device along a first projection direction; and
generating at least one second projection image by the at least one second projection device along a second projection direction, wherein an aspect ratio of the at least one first projection image along the first projection direction is different from an aspect ratio of the at least one second projection image along the second projection direction, wherein the first projection direction is perpendicular to the second projection direction.

14. The stitching method of the plurality of projection images according to claim 13, wherein an overlapping area of the at least one first projection image and the at least one second projection image is greater than or equal to 95% of the at least one first projection image.
